(19) United States
(12) Patent Application Publication
(10) Pub. No.: US 2009/0268730 A1
(43) Pub. Date: Oct. 29, 2009

(54) DATA TRANSMITTING APPARATUS AND METHOD AND PROGRAM FOR CONTROLLING TRANSMISSION RATE

(76) Inventor: Ranatunga Vijitha SANJEEWA, Kanagawa (JP)

Correspondence Address: FROMMER LAWRENCE & HAUG LLP, 745 FIFTH AVENUE, NEW YOURK, NY, 10151, US

(21) Appl. No.: 12/428,540

(22) Filed: Apr. 23, 2009

(30) Foreign Application Priority Data
Apr. 25, 2008 (JP) P2008-114779

(51) Int. Cl. H04L 12/56

(52) U.S. Cl. 370/389

(57) ABSTRACT

A data transmitting apparatus includes a plurality of data transmitting sections each transmitting a stream through a network, an information acquiring section acquiring network traffic status information of each stream, a statistical process section performing a statistical process on the network traffic status information of each stream acquired by the information acquiring section, a calculating section obtaining an overall transmission rate based on the result of the process performed by the statistical process section, and a transmission rate setting section setting a transmission rate for each stream based on the overall transmission rate obtained by the calculating section and a preset allocation ratio.

### BACKGROUND OF THE INVENTION

1. Field of the Invention

The present invention relates to a data transmitting apparatus and a method and a program for controlling a transmission rate. More specifically, the invention relates to a data transmitting apparatus which can control the rate of multi-stream transmission in a preferable manner. Specifically, the apparatus determines an overall transmission rate based on a result of a statistical process performed on network traffic status information of each stream and sets a transmission rate for each stream based on the overall transmission rate and a preset allocation ratio.

2. Description of the Related Art

Recently, increasing services provided over the internet employ data transfer according to the stream type transmission method besides the download type transmission method which has been used in the related art. Let us discuss the transmission of multimedia such as video files and audio files. According to the download type transmission method, a data file is reproduced after being once downloaded from the distribution server to a terminal at the receiving end. A file cannot be reproduced until the transfer of the file is completely finished according to this method, and the method is therefore unsuitable for reproduction that takes a long time and real-time reproduction.

According to the stream type transmission method, received data can be reproduced while the transfer of the data from the transmitting end to a terminal at the receiving end is in progress. The method is therefore used for internet services such as internet telephones, remote television conferences, and video-on-demands.

Internet techniques suitable for the stream type transmission method include RTP (Real-Time Transport Protocol) defined in IETF RFC3550. When data is transmitted according to RTP, a packet is added with a time stamp as time information, and a temporal relationship that exists between the transmitting and receiving ends of the packet can be identified from the time information. Thus, the packet can be reproduced in proper synchronization without influence of delay fluctuations (jitters) of the packet transfer.

RTP is not intended to guarantee real-time data transfers. Setting and management of packet distribution priority is not included in the category of transport services advocated in conjunction with RTP. Therefore, RTP packets can suffer from distribution delays and packet losses similarly to other types of packets. Even in such a situation, data can be reproduced at the receiving end using packets which have arrived within the expected time period. Thus, video and audio data can be reproduced to some extent even though some of the data is lost.

Techniques proposed for improving the reliability of data transfer using RTP include controlling a transmission rate using algorithm based on TFRC (TCP Friendly Rate Control) described in RFC 3448 (for example, see JP-2004-193991 (Patent Document 1)). The ARC (Adaptive Rate Control) method is an example of TFRC-based rate control.

Real-time data transfer is being increasingly diversified, and multi-stream transmission of pictures is spreading. For example, services available at recent television conferences include transmission of presentation data along with pictures and dual video transmission. In the case of a multi-stream transmission, rate control is normally exercised independently. TFRC as mentioned above properly works for a plurality of streams without any particular problem.

### SUMMARY OF THE INVENTION

When the rates of a plurality of streams are independently controlled as described above, for example, a problem can arise in that a significant change in the rate of one of the streams can affect other streams.

For example, when there is significant packet loss in a stream 1, the rate of the stream decreases, and the resultant vacancy may be used by a stream 2. This is problematic not only in that the rate of the stream 2 abruptly increases but also in that it consequently becomes difficult to restore the rate of the stream 1. Further, since the rates are controlled independently of each other, it also becomes difficult to control the ratio between the two rates. FIG. 8 shows examples of rate changes that can occur when the rates of the streams 1 and 2 are controlled independently.

It is desirable to control the rate of a multi-stream transmission in a preferable manner.

According to an embodiment of the invention, there is provided a data transmitting apparatus including:

a plurality of data transmitting sections each transmitting a stream through a network;

an information acquiring section acquiring network traffic status information of each stream;

a statistical process section performing a statistical process on the network traffic status information of each stream acquired by the information acquiring section;

a calculating section obtaining an overall transmission rate based on the result of the process performed by the statistical process section; and

a transmission rate setting section setting a transmission rate for each stream based on the overall transmission rate obtained by the calculating section and a preset allocation ratio.

According to the embodiment of the invention, each of the plurality of data transmitting sections transmits a steam through, for example, the internet. That is, multi-stream transmission is performed by the plurality of data transmitting sections.

The information acquiring section acquires network traffic status information of each stream. For example, the network traffic status information includes at least information on a packet loss rate, a round trip time (RTT), a previous transmission rate, or a receiving rate. As will be described later, when an overall transmission rate is calculated using the TCP throughput equation in IETF RFC3448, network traffic status information includes at least information on a packet loss rate and a round trip time.

The statistical processing section performs a statistical process on the network traffic status information of each stream. The term “statistical process” means a process of obtaining an average value or a process of obtaining a sum. For example, the process of obtaining an average value is performed with respect to the packet loss rates and the round trip time of streams. The summing process is performed with respect to the previous transmission rates and the receiving rates of the streams.

An overall transmission rate is obtained by the calculating section based on the result of the process performed by the statistical process section. For example, when packet loss rates and round trip times are used as network traffic status information, average values of the packet loss rates and the round trip times of the streams are used to calculate an overall transmission rate according to the TCP throughput equation in IETF RFC3448.

A transmission rate for each stream is set by the transmission rate setting section based on the overall transmission rate and an allocation rate. The allocation rate is set in advance. The data transmitting sections transmit streams at transmission rates for the respective streams thus set.

According to the embodiment of the invention, an overall transmission rate is determined based on the result of a statistical process performed on network traffic status information of each stream, and a transmission rate is set for each stream based on the overall transmission rate and a preset allocation ratio. As a result, multi-stream transmission can be performed in a manner suitable for the effective bandwidth of the network. Control can be exercised over the overall traffic that is made to flow on a network, and congestion in the network can therefore be controlled. The ratio between the transmission rates of the streams can be kept properly.

According to the embodiment of the invention, an overall transmission rate is determined based on the result of a statistical process performed on network traffic status information of each stream, and a transmission rate is set for each stream based on the overall transmission rate and a preset allocation ratio. Therefore, the rate of multi-stream transmission can be controlled in a preferable manner.

### BRIEF DESCRIPTION OF THE DRAWINGS

FIG. 1 is a block diagram showing an example of a configuration of a data communication system as an embodiment of the invention;

FIG. 2 is an illustration showing a format of an RTP packet;

FIG. 3 is an illustration showing a format of an IP header;

FIG. 4 is an illustration showing a format of an RTCP packet;

FIG. 5 is a flow chart showings steps of rate control exercised by a rate control section of a data transmitting apparatus;

FIG. 6 is a block diagram showing a schematic configuration of a data communication system in which k streams are transmitted in parallel;

FIG. 7 is a block diagram showing an example of an internal configuration of a computer executing processes at each functional unit of a data transmitting apparatus and a data receiving apparatus; and

FIG. 8 is graphs showing examples of rate changes that occur when the rates of streams 1 and 2 are controlled independently.

### DETAILED DESCRIPTION OF THE INVENTION

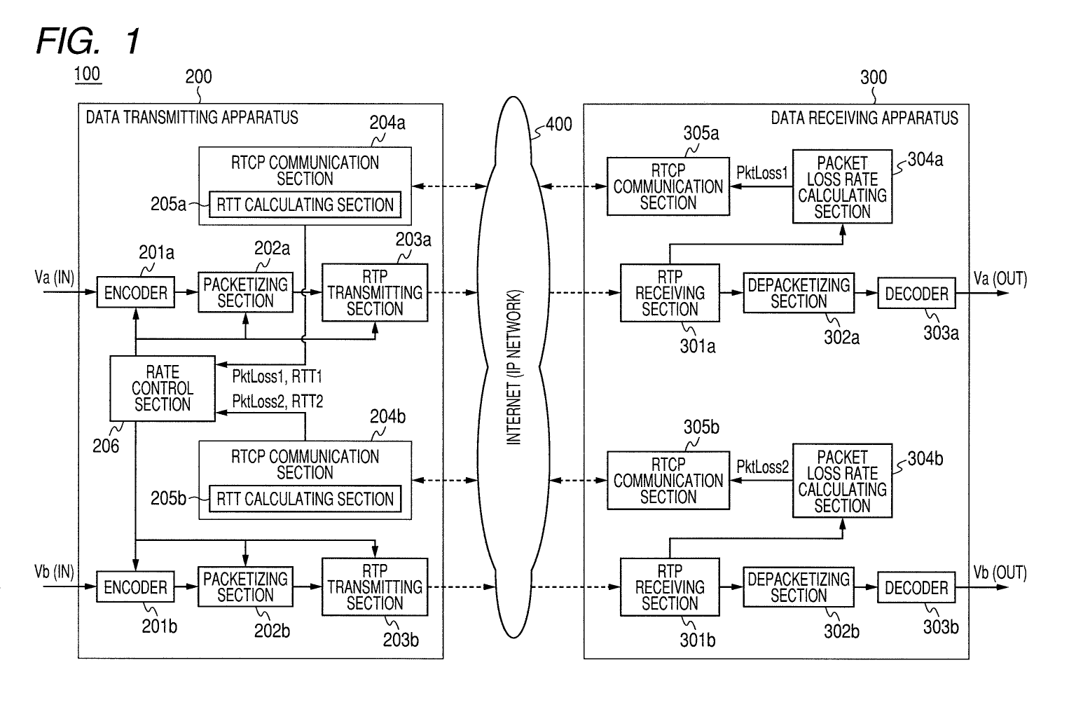

An embodiment of the invention will now be described with reference to the drawings. FIG. 1 shows an example of a configuration of a data communication system 100 embodying the invention. The data communication system 100 includes a data transmitting apparatus 200 and a data receiving apparatus 300. The data transmitting apparatus 200 and the data receiving apparatus 300 are connected through an internet 400 as a network. In the data communication system 100, two streams of data can be transmitted in parallel.

The data transmitting apparatus 200 will now be described. The data transmitting apparatus 200 includes encoders 201a and 201b, packetizing sections 202a and 202b, RTP transmitting sections 203a and 203b, RTCP communication sections 204a and 204b, and a rate control section 206. Data transmitted from the data transmitting apparatus 200 to the data receiving apparatus 300 includes video data and audio data, and the following description will focus on a configuration for transmitting video data.

The encoders 201a and 201b perform an encoding process, e.g., a compressing process according to MPEG2, MPEG4, or JPEG2000, on video data as data to be transmitted. The packetizing sections 202a and 202b packetize encoded data generated by the encoders 201a and 201b to generate datapackets. The packetizing sections 202a and 202b generate data packets (hereinafter referred to as “packets” where appropriate) according to RTP. The RTP is defined in IETF RFC1889. The packetizing sections 202a and 202b execute a process of generating packets whose payloads are encoded data. An RTP packet header is added to a piece of payload data to packetize the data.

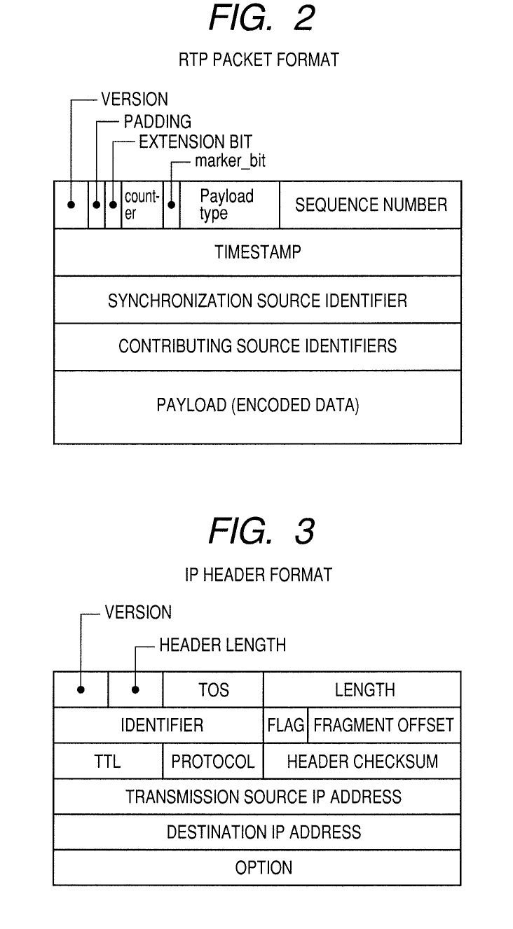

FIG. 2 shows a configuration of an RTP packet. The RTP header includes fields containing a version number (v), a padding bit (P), an extension bit indicating whether there is an extension header or not, the number of transmission sources (counter), marker information (marker bit), a payload type, a sequence number, a time stamp (TIMESTAMP), a synchronization source (transmission source) identifier (SSRC), and contributing source (transmission source) identifiers (CSRC).

At the data receiving end, control of a processing time is exercised when an RTP packet is reassembled according to the time stamp added to the RTP header, which allows control to be exercised over reproduction of real-time images or sounds. For example, in the case of RTP packets containing encoded motion picture data, a common time stamp is set in a plurality of RTP packets belonging to one video frame, and an identification flag is stored in the RTP header of an end packet forming part of each frame to indicate the frame is terminated.

Referring again to FIG. 1, the RTP transmitting sections 203a and 203b add IP headers to RTP packets supplied from the packetizing sections 202a and 202b and thereafter transmit the packets to the internet (IP network) 400. Data transmission units are formed by the encoders, the packetizing sections, and the RTP transmitting sections. In this case, a data transmission unit for transmitting a video stream 1 is formed by the encoder 201a, the packetizing section 202a,and the RTP transmitting section 203a. A data transmission unit for transmitting a video stream 2 is formed by the encoder 201b, the packetizing section 202b, and the RTP transmitting section 203b.

FIG. 3 shows a format of an IP header. The IP header includes a version field indicating the IP version such as IPv4 or IPv6, a header length field, a TOS (Type of Service) field containing priority information, a packet length field, a packet identifier field, and a flag field. The flag is control information regarding data fragmentation at the IP layer. The IP header also includes a fragment offset field indicating the location of the fragmented data, a TTL (Time to Live) field containing information on the time the data can remain before it is destroyed, a protocol field indicating the protocol used in the upper layer (for example, TCP is represented by 6, and UDP is represented by 17), a header checksum field, a source IP address field, and a destination IP address field.

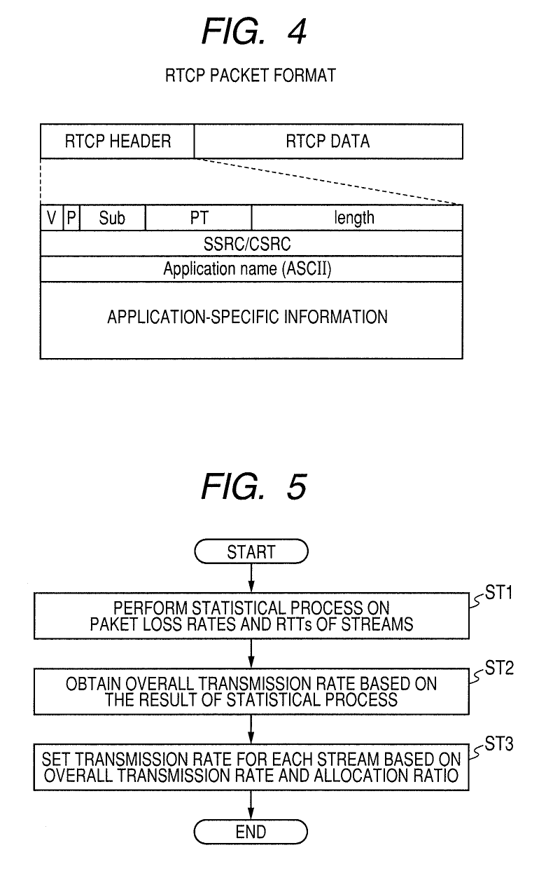

The RTCP sections 204a and 204b communicate RTCP (Real-time Transport Control Protocol) packets with the data receiving apparatus 300. RTCP is defined in IETFRFC1889. FIG. 4 shows a format of an RTCP packet. The RTCP packet includes an RTCP header and RTCP data. The RTCP header has descriptions of version information (V), padding (P), subtype, packet type, length information, SSRC/CSRC identifier, and application name that is described in ASCII. Information specific to the application is added after those descriptions.

The RTCP communication sections 204a and 204b receive at least RTCP packets which include information on the packet loss rates of the respective streams from the data receiving apparatus 300.

The RTCP communication sections 204a and 204b include RTT (Round Trip Time) calculating sections 205a and 205b, respectively. The RTT calculating sections 205a and 205b calculate the RTTs of the respective streams, for example, based on the time interval between the transmission of RTCP packets including an SR (Sender Report) block and the reception of RTCP packets including an RR (Receiver Report) block.

The packet loss rate and the RTT of each stream constitute network traffic status information of the stream. In this sense, the RTCP communication sections 204a and 204b constitute an information acquiring section.

The rate control section 206 controls the rate of each stream based on the packet loss rate (PktLoss1) and the RTT (RTT1) of the video stream 1 acquired by the RTCP communication section 204a and the packet loss rate (PktLoss2) and the RTT (RTT2) of the video stream 2 acquired by the RTCP communication section 204b. Details of the rate control exercised by the rate control section 206 will be described later.

The data receiving apparatus 300 will now be described. The data receiving apparatus 300 includes RTP receiving sections 301a and 301b, depacketizing sections 302a and 302b, decoders 303a and 303b, packet loss rate calculating sections 304a and 304b, and RTCP communication sections 305a and 305b.

The RTP receiving sections 301a and 301b receive the RTP packets sent from the RTP transmitting sections 201a and 201b of the data transmitting apparatus 200 through the internet (IP network) 400. The RTP receiving section 301a receives RTP packets associated with the video stream 1, and the RTP receiving section 301b receives RTP packets associated with the video stream 2.

The depacketizing sections 302a and 302b analyze the RTP packets received by the RTP receiving sections 301a and 301b. The depacketizing sections 302a and 302b analyze the headers and payloads of the RTP packets to reconstruct the encoded data into the form it had before packetization. The decoders 303a and 303b perform a decoding process on the encoded data reconstructed by the depacketizing sections 302a and 302b to obtain video data.

The packet loss rate calculating sections 304a and 304b calculate the packet loss rates of the respective streams received by the RTP receiving sections 301a and 301b. Specifically, the packet loss rate calculating sections 304a and 304b calculate the packet loss rates by identifying the sequence numbers of packets which have been lost based on the sequence numbers of the received RTP packets supplied from the RTP receiving sections 301a and 301b.

The RTCP communication sections 305a and 305b communicate RTCP packets with the RTCP communication sections 204a and 204b of the data transmitting apparatus 200. The RTCP communication sections 305a and 305b transmit at least RTCP packets including information on the packet loss rates of the respective streams calculated by the packet loss rate calculating sections 304a and 304b to the data transmitting apparatus 200, as described above.

Operations of the data communication system 100 shown in FIG. 1 will now be described.

Video data Va to be transmitted is supplied from a data source, which is not shown, to the encoder 201a of the data transmitting apparatus 200. At the encoder 201a, a compression/encoding process is performed on the video data Va according to MPEG to generate encoded data. The encoded data is supplied to the packetizing section 202a.

At the packetizing section 202a,the encoded data is packetized to generate data packets (RTP packets) in accordance with RTP. The data packets are supplied to the RTP transmitting section 203a. Each packet in a resultant data stream 1 is transmitted from the RTP transmitting section 203a to the RTP receiving section 301a of the data receiving apparatus 300 through the internet (IP network).

As thus described, the video stream 1 associated with the video data Va is transmitted by the data transmission unit formed by the encoder 201a, the packetizing section 202a, and the RTP transmitting section 203a to the data receiving apparatus 300 through the internet.

The RTP receiving section 301a of the data receiving apparatus 300 receives the RTP packets transmitted from the RTP transmitting section 203a of the data transmitting apparatus 200 as described above. The RTP packets received by the RTP receiving section 301a are supplied to the depacketizing section 302a.

At the depacketizing section 302a, an analysis of the headers and payloads of the RTP packets is executed to reconstruct the encoded data into the form it had before packetization. The reconstructed encoded data is supplied to the decoder 303a. At the decoder 303a, a decoding process is performed on the encoded data to acquire the video data Va associated with the video stream 1.

Video data Vb to be transmitted is supplied from a data source, which is not shown, to the encoder 201b of the data transmitting apparatus 200. At the encoder 201b, a compression/encoding process is performed on the video data Vb according to MPEG to generate encoded data. The encoded data is supplied to the packetizing section 202b.

At the packetizing section 202b, the encoded data is packetized to generate data packets (RTP packets) in accordance with RTP. The data packets are supplied to the RTP transmitting section 203b. Each packet in a resultant data stream 2 is transmitted from the RTP transmitting section 203b to the RTP receiving section 301b of the data receiving apparatus 300 through the internet (IP network).

As thus described, the video stream 2 associated with the video data Vb is transmitted by the data transmission unit formed by the encoder 201b, the packetizing section 202b, and the RTP transmitting section 203b to the data receiving apparatus 300 through the internet.

The RTP receiving section 301b of the data receiving apparatus 300 receives the RTP packets transmitted from the RTP transmitting section 203b of the data transmitting apparatus 200 as described above. The RTP packets received by the RTP receiving section 301b are supplied to the depacketizing section 302b.

At the depacketizing section 302b, an analysis of the headers and payloads of the RTP packets is executed to reconstruct the encoded data into the form it had before packetization. The reconstructed encoded data is supplied to the decoder 303b. At the decoder 303b, a decoding process is performed on the encoded data to acquire the video data Vb associated with the video stream 2.

A description will now be made on operations for controlling the transmission rate of each stream performed at the data transmitting apparatus 200.

The sequence numbers of the RTP packets received by the RTP receiving section 301a are supplied from the RTP receiving section 301a to the packet loss rate calculating section 304a of the data receiving apparatus 300. At the packet loss rate calculating section 304a, the sequence numbers of packets which have been lost are identified based on the RTP packet sequence numbers supplied from the RTP receiving section 301a to calculate a packet loss rate PktLoss1 of the video stream 1.

The packet loss rate PktLoss1 is supplied to the RTCP communication section 305a. At the RTCP communication section 305a, an RTCP packet including information on the packet loss rate PktLoss1 is generated, and the RTC packet is transmitted to the RTCP communication section 204a of the data transmitting apparatus 200 through the internet (IP network) 400.

The RTCP communication section 204a of the data transmitting apparatus 200 receives the RTCP packet including the information on the packet loss rate PktLoss1 transmitted from the RTCP communication section 305a of the data receiving apparatus 300. At the RTCP communication section 204a, the packet loss rate PktLoss1 of the video stream 1 is acquired from the RTCP packet.

At the RTCP communication section 204a of the data transmitting apparatus 200, round trip time RTT1 of the video stream 1 is calculated by the RTT calculating section 205a based on the time interval between the transmission of an RTCP packet including an SR (Sender Report) block and the reception of an RTCP packet including an RR (Receiver Report) block.

The sequence numbers of the RTP packets received by the RTP receiving section 301b is supplied from the RTP receiving section 301b to the packet loss rate calculating section 304b of the data receiving apparatus 300. At the packet loss rate calculating section 304b, the sequence numbers of packets which have been lost are identified based on the RTP packet sequence numbers supplied from the RTP receiving section 301b to calculate a packet loss rate PktLoss2 of the video stream 2.

The packet loss rate PktLoss2 is supplied to the RTCP communication section 305b. At the RTCP communication section 305b, an RTCP packet including information on the packet loss rate PktLoss2 is generated, and the RTCP packet is transmitted to the RTCP communication section 204b of the data transmitting apparatus 200 through the internet (IP network) 400.

The RTCP communication section 204b of the data transmitting apparatus 200 receives the RTCP packet including the information on the packet loss rate PktLoss2 transmitted from the RTCP communication section 305b of the data receiving apparatus 300. At the RTCP communication section 204b, the packet loss rate PktLoss2 of the video stream 2 is acquired from the RTCP packet.

At the RTCP communication section 204b of the data transmitting apparatus 200, round trip time RTT2 of the video stream 2 is calculated by the RTT calculating section 205b based on the time interval between the transmission of an RTCP packet including an SR (Sender Report) block and the reception of an RTCP packet including an RR (Receiver Report) block.

At the data transmitting apparatus 200, the packet loss rate (PktLoss1) and the RTT (RTT1) of the video stream 1 acquired by the RTCP communication section 204a as described above are supplied to the rate control section 206. The packet loss rate (PktLoss2) and the RTT (RTT2) of the video stream 2 acquired by the RTCP communication section 204b of the data transmitting apparatus 200 as described above are also supplied to the rate control section 206.

Based on the packet loss rate and the RTT of each stream, the rate control section 206 controls the transmission rate of each stream as described below. First, the rate control section 206 performs a statistical process on the packet loss rate and the RTT of each stream. In this sense, the rate control section 206 constitutes a statistical process section. A process of averaging the packet loss rates is performed to obtain an average value p=(PktLoss1+PktLoss2)/2. A process of averaging the RTTs is also performed to obtain an average value RTT=(RTT1+RTT2)/2.

Based on the result of the above-described statistical process, the rate control section 206 obtains an overall transmission rate T. In the sense, the rate control section 206 constitutes a calculating section. For example, the overall transmission rate T is calculated using Expression (1) (see the TCP throughput equation in IETF RFC3448). In Expression (1), T represents a overall transmission rate; s represents a packet size; p represents a packet loss rate (average value); and t represents a time-out time according to TCP (Transmission Control Protocol) which is normally four times a round trip time).

$$T = \frac{s}{RTT \sqrt{\frac{2 p}{3}} + t ( 3 \sqrt{\frac{3 p}{3}} ) p ( 1 + 32 {p}^{2} )} \qquad ( 1 )$$

Next, the rate control section 206 sets a transmission rate for each stream based on the overall transmission rate and a preset allocation ratio. In this sense, the rate control section 206 constitutes a transmission rate setting section. For example, when an allocation ratio of 1:1 is set for the video streams 1 and 2, a transmission rate of T/2 is set for both of the video streams. The allocation ratio between the video streams 1 and 2 is set in advance.

The encoder 201a, the packetizing section 202a, and the RTP transmitting section 203a forming the data transmission unit for transmitting the video stream 1 are controlled by the rate control section 206. In this case, the transmission rate of the video stream 1 is set by setting a data compression rate for the encoder 201a, a packet size for the packetizing section 202a, and a packet transmission interval for the RTP transmitting section 203a.

Similarly, the encoder 201b, the packetizing section 202b, and the RTP transmitting section 203b forming the data transmission unit for transmitting the video stream 2 are controlled by the rate control section 206. In this case, the transmission rate of the video stream 2 is set by setting a data compression rate for the encoder 201b, a packet size for the packetizing section 202b, and a packet transmission interval for the RTP transmitting section 203b.

The flow chart of FIG. 5 shows steps of the rate control exercised by the rate control section 206 described above. First, at step ST1, the rate control section 206 performs the statistical process (averaging process) on the packet loss rates and RTTs of the streams supplied from the RTCP communication sections 204a and 204b.

Next, at step ST2, the rate control section 206 obtains the overall transmission rate, for example, according to the TCP throughput equation in IETF RFC3448 using the result of the statistical process, i.e., the average values of the packet loss rates and round trip times of the streams.

Next, at step ST3, the rate control section 206 sets a transmission rate for each stream based on the overall transmission rate and the allocation ratio between the streams.

For example, the packet loss rates and RTTs of the respective streams are periodically supplied from the RTCP communication sections 204a and 204b to the rate control section 206, and the rate control section 206 exercises the rate control shown in the flow chart of FIG. 5. Thus, the transmission rate of each stream is automatically controlled according to network traffic status information of the data streams 1 and 2.

As described above, at the rate control section 206 of the data transmitting apparatus 200 of the data communication system 100 shown in FIG. 1, an overall transmission rate T is obtained based on results (average values) of a statistical process performed on the packet loss rates and RTTs of the streams, and a transmission rate is set for each stream based on the overall transmission rate T and a preset allocation ratio. As a result, multi-stream transmission can be performed in a manner suitable for the effective bandwidth of the network. Control can be exercised over the overall traffic that is made to flow on the network, and congestion in the network can therefore be controlled. The ratio between the transmission rates of the streams can be kept properly.

While the above-described embodiment is an application of the invention to a data transmission system 100 for transmitting two streams in parallel, the invention may be similarly applied to data communication systems for transmitting a greater number of streams in parallel.

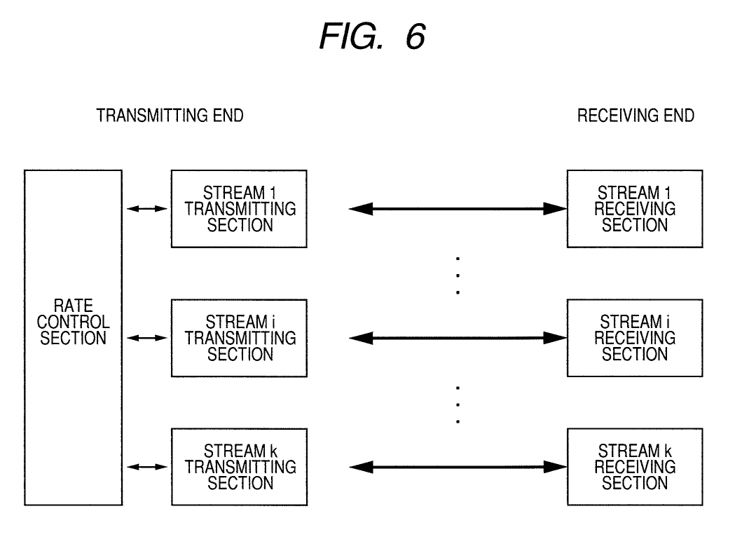

FIG. 6 shows a schematic configuration of a data communication system for transmitting k streams in parallel. In this case, a rate control section performs a statistical process on network traffic status information of the streams, and an overall transmission rate is calculated based on the result of the statistical process. A transmission rate is set for each stream based on the overall transmission rate and an allocation ratio between the streams.

While the packet loss rate and the RTT of each stream are used as network traffic status information in the above-described embodiment, the invention is not limited to the use of those pieces of information as network traffic status information. For example, the previous transmission rate and the receiving rate of each stream may be used as network traffic status information in addition to the packet loss rate and the round trip time. For example, a statistical process to be performed on previous transmission rates and receiving rates may be a process of obtaining the sums of those rates.

Expressions (2) to (5) show examples of statistical processes performed on the packet loss rates, the round trip times, the previous transmission rates, and the receiving rates of the k streams, respectively. RTTᵢ represents the round trip time of a stream i. PktLossᵢ represents the packet loss rate of the stream i. RcvRateᵢ represents the receiving rate of the stream i. PreviousRateᵢ represents the previous transmission rate of the stream i.

$$\begin{matrix}PktLoss = \frac{{\sum }_{k} {PktLoss}_{i}}{k} & ( 2 ) \\ R T T = \frac{{\sum }_{k} R T {T}_{i}}{k} & ( 3 ) \\ PreviousRate = {\sum }_{k} {PreviousRate}_{i} & ( 4 ) \\ RcvRate = {\sum }_{k} {RcvRate}_{i} & ( 5 )\end{matrix}$$

Each functional unit of the data transmitting apparatus 200 and the data receiving apparatus 300 of the above-described embodiment may be implemented on either hardware or software basis. In the case of implementation on a software basis, the processes at each functional unit are executed by a computer based on programs stored in a ROM or a hard disk.

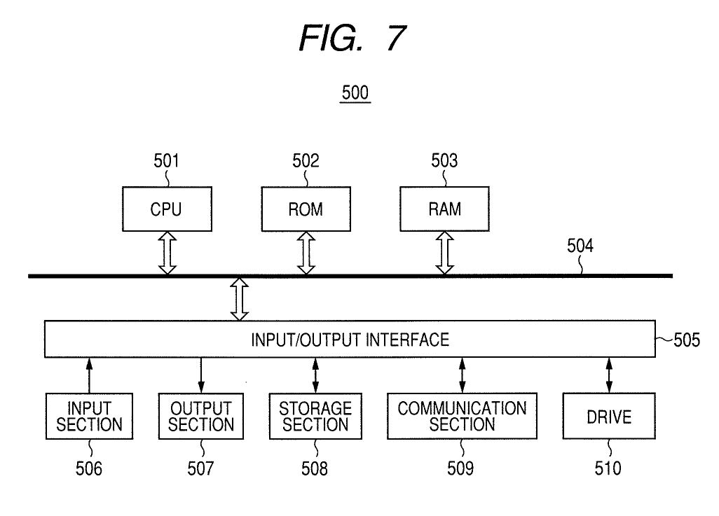

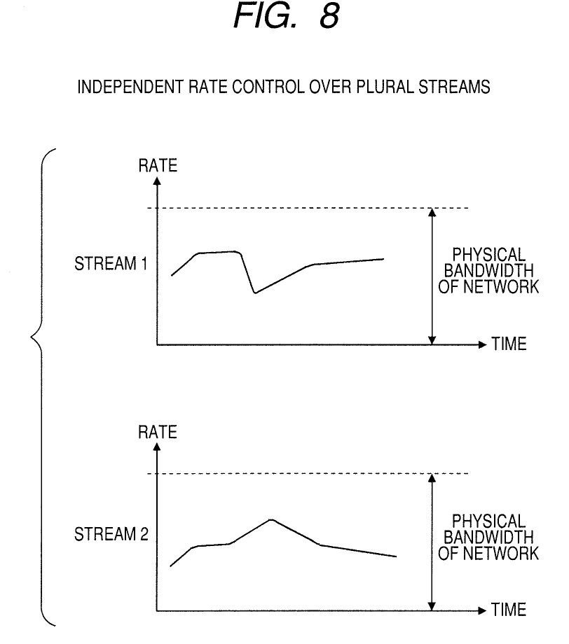

FIG. 7 is an illustration showing an example of an internal configuration of a computer 500 executing such processes. A CPU (Central Processing Unit) 501 executes various processes according to programs stored in a ROM (Read Only Memory) 502. Data and programs required for the CPU 501 to execute the various processes are stored in a RAM (Random Access Memory) 503 as occasion demands.

An input/output interface 505 is connected to a bus 504 along with the above-mentioned CPU 501, ROM 502, and RAM 503. An input section 506 including a keyboard and a mouse is connected to the input/output interface 505. The input/output interface 505 outputs signals input from the input section 506 to the CPU 501. An output section 507 including a display and a speaker is also connected to the input/output interface 505.

A storage section 508 including a hard disk and a communication section 509 for communicating data with other apparatus through a network such as the internet 400 is also connected to the input/output interface 505. A drive 510 is used for reading data from a recording medium such as a magnetic disk, an optical disk, a magneto-optical disk, or a semiconductor memory and for writing data in the medium.

The invention allows the rate of multi-stream transmission to be controlled in a preferable manner, and the invention may be used for data communication systems for transmitting video data and audio data on a multi-stream basis.

The present application contains subject matter related to that disclosed in Japanese Priority Patent Application JP-2008-114779 filed in the Japan Patent Office on Apr. 25, 2008, the entire contents of which is hereby incorporated by reference.

It should be understood by those skilled in the art that various modifications, combinations, sub-combinations, and alterations may occur depending on design requirements and other factors insofar as they are within the scope of the appended claims or the equivalents thereof.

What is claimed is:

1. A data transmitting apparatus comprising:
a plurality of data transmitting sections each transmitting a stream through a network;
an information acquiring section acquiring network traffic status information of each stream;
a statistical process section performing a statistical process on the network traffic status information of each stream acquired by the information acquiring section;
a calculating section obtaining an overall transmission rate based on the result of the process performed by the statistical process section; and
a transmission rate setting section setting a transmission rate for each stream based on the overall transmission rate obtained by the calculating section and a preset allocation ratio.

2. A data transmitting apparatus according to claim 1, wherein the network traffic status information includes at least information on a packet loss rate, a round trip time, a previous transmission rate, or a receiving rate.

3. A data transmitting apparatus according to claim 2, wherein the statistical process section performs a process of obtaining an average value with respect to the packet loss rate and the round trip time and performs a process of obtaining a sum with respect to the previous transmission rate and the receiving rate.

4. A transmission rate control method for a data transmitting apparatus having a plurality of data transmitting sections each transmitting a stream through a network, the method comprising the steps of:
acquiring network traffic status information of the plurality of streams;
performing a statistical process on the network traffic status information of each stream acquired at the information acquiring step;
calculating an overall transmission rate based on the result of the process at the statistical process step; and
setting a transmission rate for each stream based on the overall transmission rate obtained at the calculation step and a preset allocation ratio.

5. A program for a computer controlling a data transmitting apparatus having a plurality of data transmitting sections each transmitting a stream through a network, the program causing the computer to function as;
information acquiring means for acquiring network traffic status information of each stream;
statistical process means for performing a statistical process on the network traffic status information of each stream acquired by the information acquiring means;
calculating means for obtaining an overall transmission rate based on the result of the process performed by the statistical process means; and
transmission rate setting means for setting a transmission rate for each stream based on the overall transmission rate obtained by the calculating means and a preset allocation ratio.
